(19) United States
(12) Patent Application Publication
(10) Pub. No.: US 2006/0145871 A1
(43) Pub. Date: Jul. 6, 2006

(54) Radio Frequency Identification for Medical Devices

(75) Inventors: Ralph Donati, Germantown, TN (US); Randall Troutman, Cordova, TN (US)

Correspondence Address: CHIEF PATENT COUNSEL;SMITH & NEPHEW, INC., 1450 BROOKS ROAD, MEMPHIS, TN, 38116, US

(73) Assignee: Smith & Nephew, Inc., Memphis, TN (US)

(21) Appl. No.: 11/275,012

(22) Filed: Dec. 1, 2005

Related U.S. Application Data
(60) Provisional application No. 60/632,679, filed on Dec. 2, 2004.

(51) Int. Cl. G08B 13/14; G08B 1/08

(52) U.S. Cl. 340/572.8; 340/539.1

(57) ABSTRACT

This invention relates to a system and method for identifying sterilized medical devices located within a sealed sterilization case in preparation for a surgical procedure. Radio frequency identification (RFID) tags are connected to the medical device and communicate information via radio frequency to an RFID tag reader located on the outside of the sealed sterilization case. The reader is in electrical or wireless communication with a database. The reader sends the information obtained from the RFID tags to the database where it is compared with the information in the database. The results may be displayed on the interface thereby providing the user with information about the medical instruments contained in the sealed sterilization case without breaking the seal of the sealed sterilization case.

### CROSS REFERENCE TO RELATED APPLICATIONS

This application claims the benefit of U.S. Provisional Application No. 60/632,679, filed Dec. 02, 2004.

### TECHNICAL FIELD OF INVENTION

This invention relates to systems and methods for identifying sterilized medical devices located within a sterilization case that is sealed with a wrap in preparation for a surgical procedure.

### BACKGROUND OF THE INVENTION

Surgical procedures generally involve various sterilized instruments. Sterilization can occur by known techniques such as autoclaving or those utilizing substances such as ethylene oxide, vapor hydrogen peroxide, or ozone. Before sterilization, the surgical instruments are placed inside a sterilization case that is typically made from either steel, aluminum, titanium, or plastic. The sterilization case is then wrapped in a plastic sheet and sealed. The plastic normally allows particles, condensed water, water vapor, and other substances to leave the sterilization case but prevents foreign contaminants from entering the sterilization case. Upon completing the sterilization process, the sterilization case containing the medical instruments is still within the sealed wrap. Prior to the surgical procedure and in the sterile field of the operating room, the instruments are typically removed from the wrap and sterilization case, placed on a table, and counted to validate that all instruments needed for the particular surgical procedure are on the table.

Hospitals, instrument management companies, and sterilization companies often have difficulty tracking and managing surgical instruments as they pass through the purview of various parties in the supply chain. For instance, instruments are sometimes misplaced, which may remain unknown until the instruments are removed from the sterilization case and the wrap in the sterile field of the operating room prior to surgery. If one or more instruments needed for the surgery are missing, personnel must open another sealed plastic wrap to retrieve the missing instruments or locate a replacement within the hospital. Personnel associated with surgical preparation sometimes need to open several sealed packets before they obtain a complete set of necessary instruments or spend time searching the hospital or other facility for a replacement. Furthermore, the remaining instruments in the second sterilization case and those opened thereafter, even if not used in a surgical procedure, always must be sterilized again.

Various methods of counting the surgical instruments are known, but none are particularly efficient. One method involves a person physically counting each instrument on the surgical instrument tray and then comparing the count result to an information sheet that provides an inventory list of instruments used in a particular surgery. This count is usually performed close to, but before, the scheduled surgery while the patient is either already on the surgical table or on their way to the surgical room. If there is a discrepancy between the count and inventory list, the person counting or their assistant must quickly determine which instrument is missing and where a suitable replacement may be located before the surgical procedure begins.

Such tracking processes require time to count the instruments manually, determine if there is a discrepancy between the count and the inventory list, and locate a replacement instrument. This time is costly to both the instrument company and hospital and could needlessly delay surgery. In addition, there is a likelihood for human error in counting the instruments and comparing the count to the inventory list. Furthermore, the correct instruments for a particular surgical procedure may still be missing during surgery, forcing the surgeon to use a closely related, but incorrect, instrument to perform the procedure. Manually tracking medical instruments also requires that the surgical instruments be removed from the wrap and the sterilization case before they are counted and compared to the inventory list for discrepancies.

Other methods to count surgical instruments and compare to an inventory list involve electronic means. One such method utilizes an optical scanner, in communication with a computer and database, that reads an encoded optical pattern of a bar code attached to each surgical instrument. Individual surgical instruments may be identified by the encoded optical pattern of the attached bar code. The optical scanner usually converts the encoded optical pattern of a bar code into an electrical signal that represents an identification code associated in the database with a particular surgical instrument. The computer typically contains a memory with database information about each surgical instrument and correlates that information to the identification code. The computer may then be programmed to produce information to a user in a variety of formats useful in an inventory procedure.

Optical scanning, however, has several disadvantages in its application to inventory surgical instruments. For example, the size of a bar code is sometimes too large for placement on relatively small surgical instruments. It also takes time to scan and inventory a group of medical instruments. Optical scanning techniques require the user to present the optical scanner in close proximity to and in the line of sight of the bar code on each surgical instrument and orient the scanning device appropriately to the bar code. Furthermore, each surgical instrument and attached bar code must be scanned individually. The time required to perform an inventory of surgical instruments one at a time is relatively large and costly to the instrument company and hospital and can needlessly delay a surgical procedure.

Another disadvantage of an optical scanning procedure is the opportunity for human error. If the user does not orient the optical scanner correctly with respect to a bar code on a surgical instrument, the scanner could fail to read that item and it could be deemed missing when it is actually present in the surgical instrument group. Furthermore, some optical scanning systems alert the user with a beep, light, or some other visible or audible signal upon a successful scan. Interfering noise within the operating room or a user that becomes distracted may cause the user to miss an identified surgical item. If a surgical item is missed, there may be costly and needless delay in finding a replacement instrument.

Another disadvantage of an optical scanning procedure is that even if the scanning process correctly determines that one or more instruments are missing, often another packet must be opened to retrieve the particular missing instruments. The results of the optical scanning procedure includes the sterilization of the remaining instruments of the second opened packet, even if not used in a surgical procedure. This adds considerable cost and time to a hospital and instrument management company's surgical preparation procedures.

Another method as described below for managing medical instrument locations prior to and during surgery utilizing electronic means involves attaching certain radio frequency identification (RFID) tags to surgical instruments and a reader that obtains information associated with the particular medical instrument through radio frequency. RFID tags typically comprise an electronic circuit placed on small substrate materials. The electronic circuits contain encoded data and transmit or respond (actively or passively) with encoded or identifiable data as a radio frequency signal or a signature when an interrogation radio frequency signal causes the electronic circuit to transmit or respond (whether actively or passively). Some RFID tags are able to have their data modified by an encoded radio signal.

A reader is a radio frequency emitter/receiver or interrogator. In accordance with general RFID tag methodology, the reader interrogates RFID tags that are within its range by emitting radio frequency waves at a certain frequency. Each tag may respond to a unique set of interrogation frequencies. An RFID tag typically responds to an interrogation by emitting or responding with coded or identification information as a radio frequency signal or signature and this signal or signature (whether actively or passively) is detected by the reader. The reader is in electrical communication with a computer system having a database of information about the inventory. After detecting the radio frequency signal from the RFID tag, the reader causes the computer system to change the data in the database to account for the presence of a particular inventory item.

An RFID tag system has several advantages over manual counting and optical scanning systems. For instance, the RFID tag reader is not required to be aimed directly at a tag in order to detect a signal. An RFID tag system does not require the user to orient a reader with respect to a particular tag in order to obtain the information as the optical scanning system requires. An additional advantage of an RFID tag system is the capability of quickly performing an inventory of a large group of items by successively reading a tag associated with each item without requiring the user to perform multiple procedural steps. This saves time and expense relative to manual and optical scanning systems.

Known RFID tag systems have been used to manage medical instrument locations prior to and during surgery. For instance, the surgical tray table may be scanned prior to the surgery to ensure that all instruments needed for the procedure are present. Prior to completing the surgery, the surgical tray table may be scanned again to ensure that instruments are located on the tray table instead of inside the patient. Some RFID tag systems describe scanning the surgical cavity of the patient to check for the presence of any instruments prior to completing the surgery.

Previous and current RFID tag systems used to manage and inventory medical instruments require that surgical personnel break the sterilization seal of a group of instruments and remove the instruments from the packet before the reader reads medical instruments. This is because instruments are typically contained within a metallic sterilization case and the sterilization case prevents electromagnetic energy, such as a radio frequency signal, from entering or leaving the case. Thus, an RFID reader is unable to communicate with the RFID tags located inside the sterilization case and the instruments must be removed from the case, including breaking the sealed wrap, in order for the reader to determine the inventory of a particular group of instruments. If, after reading the removed medical instruments, the medical instrument group does not include an instrument necessary for the particular surgical procedure, hospital or medical instrument company representatives must break another sealed sterilization packet, remove the instruments from the case and read or interrogate the RFID tags of that group to find the instrument necessary to complete the first instrument group. This process includes high costs and time delays in preparing for a surgical procedure.

A medical instrument inventory and management system that allows personnel to read data regarding the individual medical instruments contained within a sealed sterilization case would decrease the time necessary to locate a particular instrument. In addition, determining the presence of particular medical instruments inside a sealed sterilization case could decrease the time and cost of preparing for a surgical procedure since breaking a second and additional sealed packets requires another cleaning, decontamination, and sterilization process. Furthermore, personnel could read the inventory of several packets and select the one with the correct instrument group for a particular medical procedure.

### SUMMARY OF THE INVENTION

Accordingly, the present invention relates generally to systems and methods for identifying medical instruments without breaking a sealed wrap surrounding the sterilization case and instruments and managing and taking an inventory of medical instruments. An RFID tag is affixed to each medical instrument prior to the sterilization procedure. Each RFID tag contains, or is associated with, information related to the particular medical instrument to which it is attached. The medical instruments, along with their respective attached RFID tags, are placed inside a sterilization case which is typically metal or another material that is not conducive to allowing electromagnetic energy, such as radio frequency signals, to enter or leave the case. A plastic covering may then be wrapped around the sterilization case and sealed to prevent any contaminants from entering the sterilization case. The instrument packet enters a sterilization process to remove contaminants from the medical instruments. After the sterilization process, the instruments remain in the sealed sterilization case.

Prior to the surgical procedure, a reader scans the instruments contained in the sealed sterilization case. A reader is brought within proximity of the instrument packet and transmits one or more signals that are received by RFID tags contained within the packet. The RFID tags respond actively or passively, such as by transmitting or evidencing a responsive signature with encoded data or other identifying data. The sterilization case is configured to allow electromagnetic energy, such as radio frequency signals, to enter and leave the case. Configurations could include holes, slits, or any other opening or openings in at least one side of the sterilization case specially adapted in size and/or shape to allow radio frequency signals to pass through the case. In an alternative embodiment, the sterilization case may be made from a material such as plastic, paper products, wood, cloth, vinyl, leather, or any material that allows radio frequency signals to enter and leave the case. The reader compares this data set to a database either contained within the reader or contained within another device (i.e. a computer or network) that is in communication with the reader. Information in the database corresponding to the encoded data or identifying information is then displayed to the user on an interface contained within the reader or within a separate device. This information could include the identification of the medical instrument or any other aspect regarding each individual medical instrument or the medical instrument packet.

If the displayed results indicate that all instruments needed for the particular procedure are located inside the packet, the user may break the sealed wrap and remove the medical instruments from the sterilization case. If the displayed results indicate that some instruments are missing from the packet, another packet may be quickly selected and read to determine if it contains all the necessary instruments for a particular surgical procedure. In the alternative, the user may select and read a second packet to determine if the instruments missing in the first read packet are located in the second read packet. Based on the information obtained by reading the packets, the appropriate packet may be selected and its sealed wrap broken for a particular procedure. In the alternative, the user may quickly determine the two packets on which to break the sealed wrap in order to complete a medical instrument set for a particular surgical procedure.

An advantage of certain aspects and embodiments of the present invention is to provide an efficient and quick system to ensure that the correct medical instruments are present prior to the start of a particular surgical procedure.

A further advantage of certain aspects and embodiments of the present invention is to decrease the number of sealed packets containing groups of instruments inside a sterilization case that must be broken and the instruments removed from the sterilization case in order to complete a set of medical instruments for a particular surgical procedure.

A still further advantage of certain aspects and embodiments of the present invention is the ability to provide medical personnel with the surgical techniques, manufacturing history, and origination associated with particular medical instruments.

A still further advantage of certain aspects and embodiments of the present invention is that it decreases the chance for human error involved in the medical instrument inventory and management process.

A still further advantage of certain aspects and embodiments of the present invention is that it decreases the amount of time hospital personnel spend preparing for a surgical procedure.

A still further advantage of certain aspects and embodiments of the present invention is the efficient use of a medical instrument company representative's time in ensuring the surgeon receives the correct medical instruments for a particular procedure, receives those instruments prior to surgery, and that those instruments are appropriately sterilized.

### BRIEF DESCRIPTION OF THE DRAWINGS

FIG. 1 shows a sterilization case and RFID tag reader according to one embodiment of the invention.

FIG. 2 shows a sealed wrap over a sterilization case and RFID tag reader according to one embodiment of the invention.

FIG. 3 shows a second medical instrument packet and RFID tag reader according to one embodiment of the invention.

FIG. 4 shows a medical instrument with an RFID tag located on the outside surface of the instrument according to one embodiment of the invention.

FIG. 5 shows a medical instrument with an RFID tag embedded in the instrument according to one embodiment of the invention.

FIG. 6 shows a reader electrically connected to a computer system according to one embodiment of the invention.

### DETAILED DESCRIPTION OF THE INVENTION

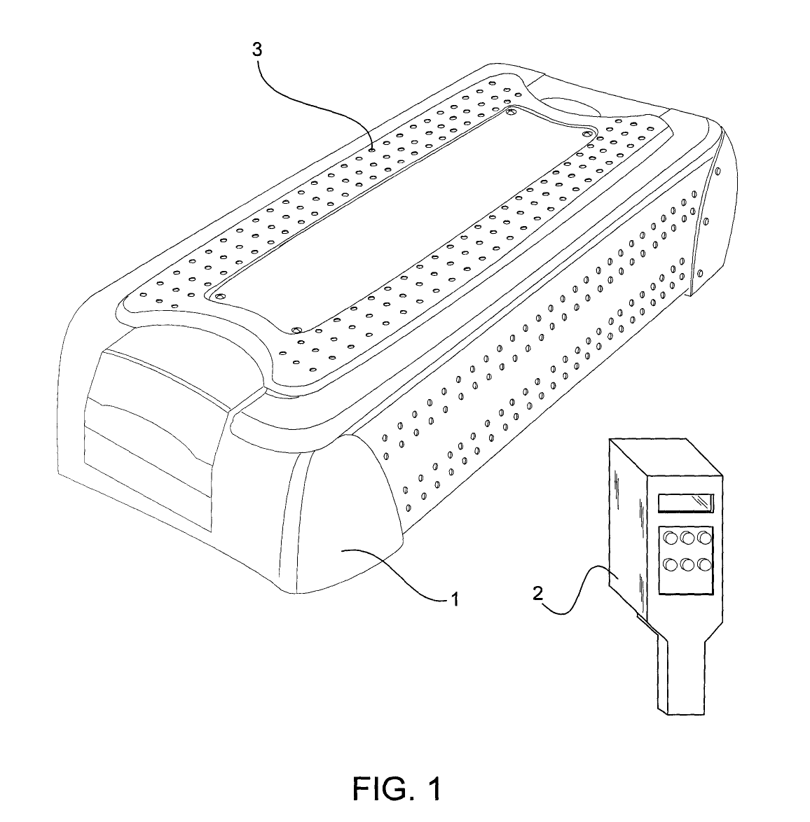

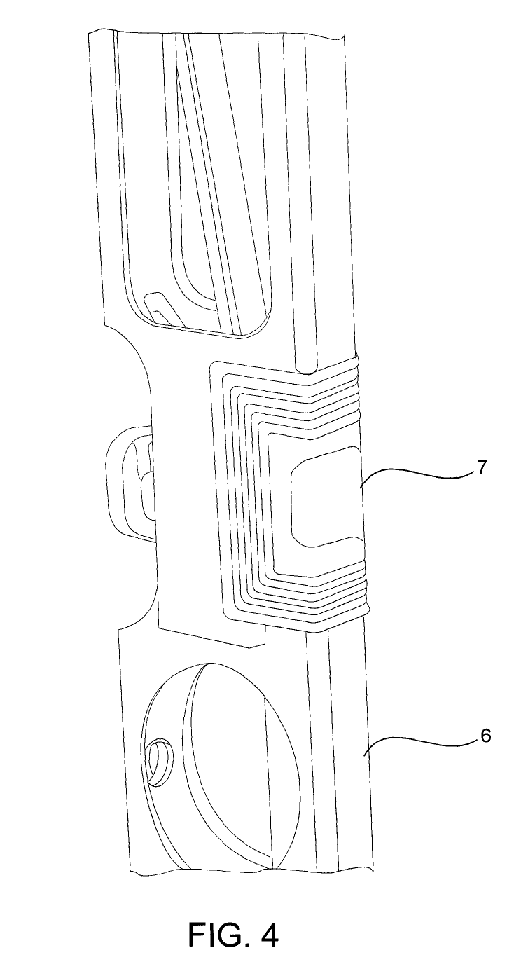

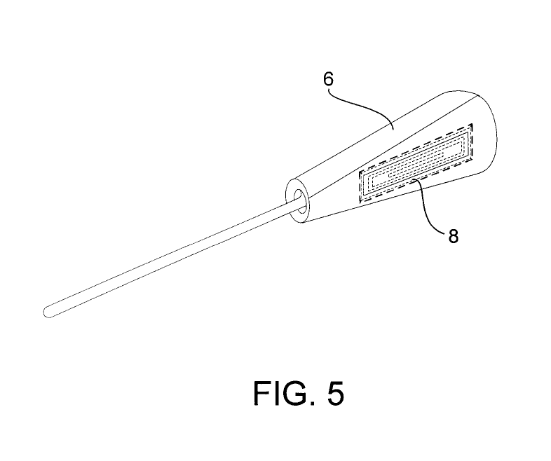

Referring initially to FIG. 1, illustrated is a system for identifying medical devices according to one embodiment of the invention. Included in this embodiment is a sterilization case 1 and an RFID reader 2 configured to communicate with RFID tags. The sterilization case 1 may contain various medical instruments, such as medical instruments 6 shown in FIGS. 4 and 5, and RFID tags, such as RFID tags 7 and 8 shown in FIGS. 4 and 5. It should be understood that other types of medical instruments and RFID tag configurations may be used with the several embodiments of the present invention. RFID tags 7 and 8 are attached to, associated with, or embedded in the medical instruments 6. FIG. 4 shows one embodiment of the invention where an RFID tag 7 is associated or attached to medical instrument 6. FIG. 5 shows another embodiment of the invention where an RFID tag 8 is embedded in the medical instrument 6.

In some embodiments, RFID tags 7 and 8 are attached to the medical instruments 6 by an adhesive substance such as glue, paste, gum, epoxy resin, tape, bonding agent, or any other type of adhesive that will attach the RFID tags 7 and 8 to the medical instrument 6. In other embodiments, RFID tags 7 and 8 are attached to the medical instruments 6 by a mechanical device such as a clip, fastener, clasp, pin, screw, or any other device that will mechanically associate an RFID tag to a medical instrument. In other embodiments, RFID tags 7 and 8 may be attached to the medical instruments 6 by molding or otherwise, including during manufacture of medical instruments 6 or otherwise.

Referring again to FIG. 1, in some embodiments, the sterilization case 1 may be made from steel, aluminum, titanium, plastic or any other appropriate material that will provide containment for sterilization purposes. In some embodiments, the sterilization case 1 may include at least one side with at least one opening 3, such as holes, slits, or any other type and size of opening or openings in at least one side of the sterilization case shaped and sized to allow RFID tags 7 and 8 in the sterilization case 1 to respond to a reader 2. In other embodiments, at least one side of the sterilization case 1 may be made from materials such as plastic, paper products, wood, cloth, vinyl, leather, or any other appropriate material that allows radio frequency signals to enter and leave the case.

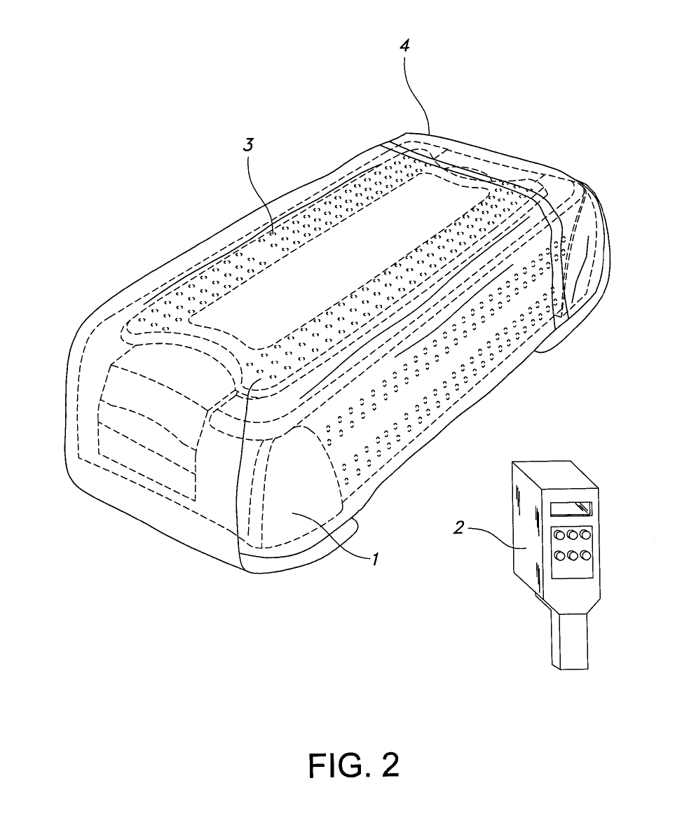

Referring now to FIG. 2, illustrated is another alternative embodiment of the present invention. Included in this embodiment is a reader 2 and a sealed wrap 4 surrounding a sterilization case 1 with at least one opening 3. The sealed wrap 4 may be composed of assorted materials such as various combinations of plastic, paper, polyethylene film, polyester film, foil, laminate material, polypropylene, polyolefin, polymusum, or any other material that may be used to wrap the sterilization case for sterilization purposes.

RFID tags 7 and 8 of certain embodiments of the invention, associated with medical instruments 6 and located inside the sterilization case 1, have the capability of transmitting or responding with encoded data or a signature when they are interrogated by a reader 2. The RFID tags of the preferred embodiment are passive, in that they do not contain an independent energy source but must depend on the radio frequency signal from the reader to provide its response or signature. An alternative embodiment of the present invention includes active RFID tags that contain an independent energy source, such as a battery or other means, so that the RFID tag can actively transmit a signal or information.

The preferred embodiment of the reader 2 is shown as a handheld device capable of transmitting a signal via radio frequency to the RFID tags 7 and 8 and receiving encoded data or RFID tag signatures via radio frequency from the RFID tags 7 and 8. The preferred embodiment of the reader 2 also has the capability of outputting the received data onto a viewable interface or to a computer via electrical or wireless connection. It should be understood by those with skill in the art that the reader 2 may take any stationary or movable form with the function of reading RFID tags. For example, in an alternative embodiment of the present invention the reader 2 is a mat and the sterilization case 1 containing the medical instruments 6, may be placed on the mat. The reader 2 then reads the RFID tags attached to the medical devices.

When the sterilization case 1 is made from steel, aluminum, titanium, or any type of metal, radio frequency communication between an RFID tag 7 and 8 and a reader 6 may be greatly attenuated and the presence of metal may prevent all communication. The sterilization case, however, may be modified to allow radio frequency communication between the RFID tags 7 and 8 and reader 2. Modifications to the sterilization case may include openings 3 such as holes, slits, or any other type and size of opening in at least one side of the sterilization case. In other embodiments the sterilization case 1 may be made from a material, such as plastic, paper products, wood, cloth, vinyl, metal or leather, that allows radio frequency signals to enter and leave the case. In still other embodiments, a master RFID tag or reader may be attached to the outside of the sterilization case to collect information from inside the case and communicate the information to an external reader.

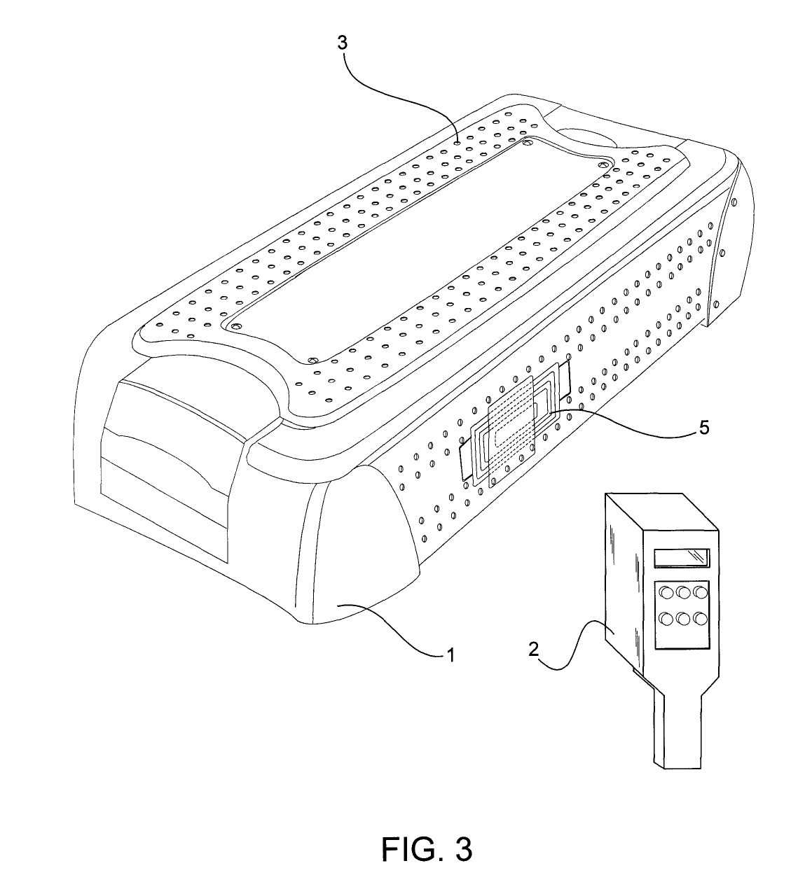

Referring now to FIG. 3, illustrated is another alternative embodiment of the present invention. Included in this embodiment is a sterilization case 1 and RFID tag reader 2. The sterilization case 1 contains RFID tags attached to medical instruments. The sterilization case 1 also contains a case RFID tag 5 attached on the outside of at least one of the sterilization case's 1 surfaces. In some embodiments, the case RFID tag 5 has the capability of receiving a signal from the reader 2 and then transmitting or responding with encoded data or identifying information to the reader 2. In other embodiments, the case RFID tag 5 may communicate through radio frequency signals to the RFID tags associated with the medical instruments located inside the sterilization case 1. The case RFID tag 5 then communicates the information received from the RFID tags inside the case to the reader 2.

In certain embodiments of the present invention, the type of data transmitted by the RFID tags 7 and 8 and case RFID tag 5 to the reader 2 may include the identification of the medical instruments 6 to which the RFID tags 7 and 8 are attached, the contents of the entire sterilization case 1, the surgical technique associated with a particular medical instrument 6 or group of medical instruments contained within the sterilization case 1, surgical implants with which the instrument 6 is to be used, the manufacturing history of a particular medical instrument 6, how many times the instrument 6 has been sterilized, or any other relevant data associated with the instruments, group of instruments, or case. Alternatively, the RFID tags 7 and 8 may respond with a signal or signature that keys or correlates to such information in a database in the computer system or on a network such as the Internet or a local network. One may see that a number of different types of data may be conveyed with or keyed to information conveyed using RFID tags 7 and 8 and case RFID tag 5. In the preferred embodiment, the RFID tags 7 and 8 transmit or respond with data that corresponds to the identification of a particular medical instrument 6 and the case RFID tag 5 transmits data corresponding to the identification and contents of a particular sterilization case 1.

Referring now to FIG. 4, illustrated is the preferred embodiment of an RFID tag 7 attached to a medical instrument 6. The RFID tag 7 is attached on the outside surface of the medical instrument 6. Various methods may be utilized to attach the RFID tag 7 on the outside surface of the medical instrument 6. For example, the RFID tag 7 may be attached on the outside surface of the medical instrument 6 through any adhesive or mechanical device. In some embodiments, the adhesive substance may be glue, paste, gum, epoxy resin, tape, bonding agent, or any other type of adhesive that will attach an RFID tag 7 to a medical instrument 6. In other embodiments, RFID tags 7 are associated to the medical instrument 6 by a mechanical device. The mechanical device may be a clip, fastener, clasp, pin, screw, or any other device that will mechanically associate an RFID tag to a medical instrument.

Referring now to FIG. 5, illustrated is one embodiment of a RFID tag 8 attached to a medical instrument 6. In this particular embodiment, the RFID tag 8 is embedded inside the medical instrument 6 and is not viewable from the surface of the medical instrument 6. Various procedures may be utilized to embed the RFID tag 8 into medical instrument 6 such as removing a portion of the medical instrument and replacing the portion with an RFID tag 8. Other procedures apparent to those of ordinary skill in the art may be utilized to embed the RFID tag 8.

Referring again to FIG. 2, to inventory and manage medical instruments while they are in a sealed wrap 4, the user begins by waving the reader 2 in proximity to the sealed and wrapped sterilization case 1. This distance between the reader 2 and sterilization case 1 may be as little as 5 millimeters to as much as several feet or more. In an alternative embodiment of the present invention, the reader 2 may be stationary while the user locates the sealed and wrapped sterilization case 1 in proximity to a stationary reader 2. The reader 2 transmits a radio frequency signal interrogating the RFID tags associated with medical instruments inside the sterilization case 1. The RFID tags respond to the interrogation by transmitting a radio frequency signal or responding with a signature containing encoded or indicative data. The reader 2 receives these signals and sends them to a computer and/or correlates them to a database contained within the reader 2 or elsewhere such as on a network.

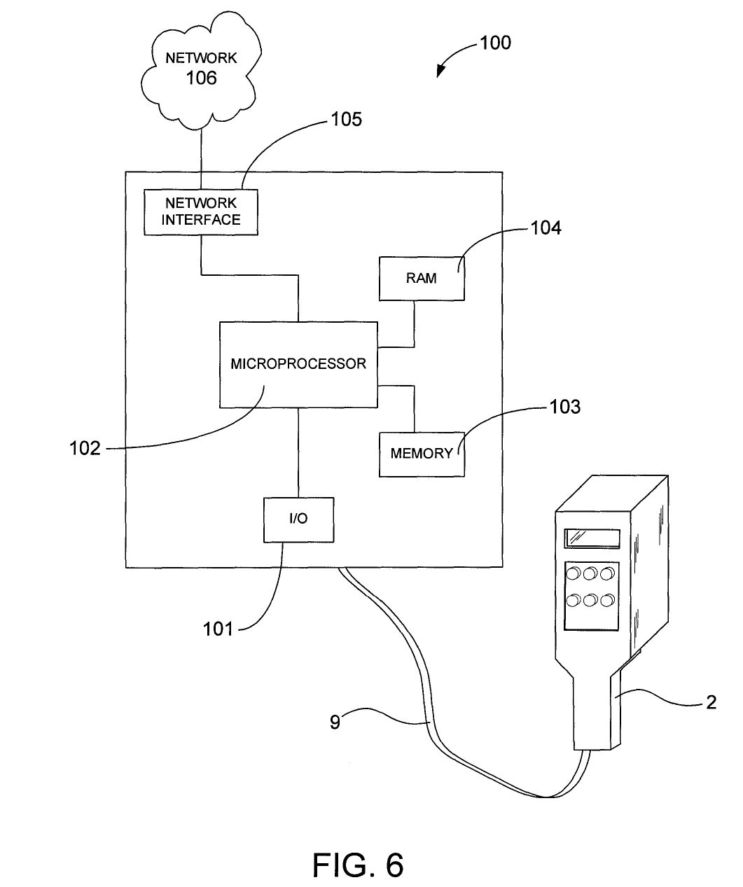

Referring now to FIG. 6, in the preferred embodiment of the present invention, the reader 2 sends the encoded or indicative data to a computer system 100 via electrical signals along a cable 9. In an alternate embodiment of the present invention, the reader 2 communicates the encoded or indicative data received from the RFID tags via wireless connection to a computer system 100. In some embodiments, the computer system 100 includes an input/output 101, microprocessor 102, memory device 103, random access memory 104, and network interface 105. The input/output 101 takes in the information from the reader and sends the information to the microprocessor 102. The microprocessor 102 compares the information with a database in the memory 103 and/or random access memory 104. The microprocessor 102 then displays the results onto an interface, such as a monitor, that may be viewed by a user, sends the information in the memory 103 for storage, and/or sends the results to a network interface 105 that is in communication with a network 106. The network 106 may include a plurality of computer systems, an Internet, a local area network, or any type of network systems capable of processing or transferring data.

In an alternative embodiment the reader 2 comprises a database and viewable interface. The reader 2 compares the encoded data with the database and the results on the viewable interface.

The user may utilize the results displayed on the interface to determine whether all necessary instruments for a particular surgical procedure are contained within the packet, if some necessary instruments are missing to locate them in another instrument packet, or to locate a packet that contains all necessary instruments.

One example in accordance with the present invention is as follows. In preparation for a surgical procedure, such as a total knee replacement, members of medical device central processing sterilize the medical instruments to be used. A variety of medical instruments may be sterilized, such as a cutting block, fin stem punch, femoral trial, and patella clamp.

Prior to sterilization, a passive RFID tag, such as those manufactured or supplied by Danby, TTP, QuintiQ, or Precimed may be attached to each medical instrument. The RFID tag is preferably attached by an instrument management company to the medical instruments with an epoxy adhesive, but may be attached immediately prior to sterilization by a clip or some other mechanical method.

The medical instruments, with an RFID tag attached to each one, are placed inside a sterilization case, such as model number 7112-9401/9402/9400 manufactured by Smith and Nephew. The sterilization case is wrapped in a plastic wrap, such as Kimberly-Clark 600 sterilization pouch or sterilization wrapper, and the wrap is then sealed.

The sealed sterilization case containing the medical instruments is placed in the sterilization pouch and the pouch is sealed. The completed assembly is then placed into an autoclave and subjected to a medical autoclave sterilization process. The sterilization case is removed then from the autoclave and placed on a shelf.

The wrapped instrument cases are taken to a central storage location. When the case is scheduled, they are taken to a staging area or up to the operating room. Just prior to surgery, a medical instrument sales representative, hospital employee, or nurse scans the instrument packets in central processing, a staging area, or in the operating room with an RFID reader. The reader is preferably a handheld reader, but may also be a mat reader, a stationary reader, or any other reader disclosed herein. In a particularly preferred embodiment, the reader is handheld and is scanned over the wrapped sterilization case prior to the sealed outer wrap being broken.

The information obtained from the RFID tag is sent, preferably through wireless connection, to a computer or handheld computing device, such as a Hewlet-Packard iPAQ or a network. In an alternative embodiment, the information is displaced on a screen located on the reader. The output may show, for example, a sterilization case list, the contents of the case, the part numbers necessary for a procedure, which instruments are missing, or any information relevant to medical instrument inventory and management. If the interface indicates that all instruments necessary for the procedure are present, then the sealed plastic wrap is broken, the instruments are removed from the sterilization case, and laid on a tray table in the operating room. If the interface indicates that all instruments necessary for the procedure are present, then the person scanning would notify someone assisting in the surgery that the packet is not complete and that another packet is read to supplement or replace the first packet.

What is claimed is:

1) A system for identifying medical instruments in a sealed sterilization case comprising:
a sealed sterilization case adapted to allow radio frequency signals to pass through at least one side of the case;
at least one radio frequency identification tag;
at least one medical instrument contained in the sealed sterilization case and attached to the radio frequency identification tag; and
a reader adapted to obtain information, via radio frequency, from said radio frequency identification tag.

2) A sterilization case in claim 1 further comprising at least one surface that has at least one opening adapted in size or shape to allow radio frequency signals to enter and leave the case.

3) A sterilization case in claim 1 composed of a material that is configured to allow radio frequency signals to enter and leave the case.

4) A system for identifying medical instruments in a sealed sterilization case according to claim 1 wherein the radio frequency identification tag associated with the instrument is embedded inside the instrument.

5) A system for identifying medical instruments in a sealed sterilization case according to claim 1 wherein the radio frequency identification tag associated with the instrument is attached on the outside surface of the medical instrument.

6) A system for identifying medical instruments in a sealed sterilization case according to claim 1 wherein each of the radio frequency identification tags is a passive device.

7) A system for identifying medical instruments in a sealed sterilization case according to claim 1 wherein each of the radio frequency identification tags is an active device.

8) A system for identifying medical instruments in a sealed sterilization case according to claim 1 wherein the reader is electrically connected to a microprocessor.

9) A system for identifying medical instruments in a sealed sterilization case according to claim 1 wherein the reader is in wireless communication with a microprocessor.

10) A system for identifying medical instruments in a sealed sterilization case according to claim 1 wherein the information includes at least one of the following:
the identification of the medical instrument to which the radio frequency identification tag is associated with;
the surgical technique associated with the medical instrument to which the radio frequency identification tag is associated with; and
the manufacturing history of the medical instrument to which the radio frequency identification tag is associated with.

11) A system for identifying medical instruments in a sealed sterilization case according to claim 1 further comprising a case radio frequency identification tag attached or associated with the outside of the sterilization case.

12) A system for identifying medical instruments in a sealed sterilization case according to claim 11 wherein the case radio frequency obtains information, via radio frequency, from the radio frequency tags associated with the medical instruments and communicates the information via radio frequency to the reader.

13) A method for identifying medical instruments in a sealed sterilization case comprising the steps of:
providing a medical instrument having a radio frequency identification tag attached to or associated with the medical instrument;
providing a sterilization case configured to allow radio frequency signals to enter and leave the case and inserting each medical instrument and radio frequency identification tag into the sterilization case;
inserting and sealing the sterilization case in a sealed wrap; and
reading the identification tag located inside the sealed wrap.

14) A sterilization case in claim 13 further comprising at least one surface that has at least one opening.

15) A sterilization case in claim 13 composed of a material configured to allow radio frequency signals to enter and leave the sterilization case.

16) A sterilization case in claim 13 further comprising a case radio frequency identification tag associated with the sterilization case, wherein the case radio frequency identification tag is configured to obtain information from the radio frequency tag associated with a medical instrument via radio frequency and to communicate the information to a reader.

17) A method for identifying medical instruments according to claim 13 wherein the information includes at least one of the following, the identification of the medical instrument packet contained within the sterilization case;
the surgical technique associated with the medical instrument packet; and
the manufacturing history of the medical instrument packet

18) A method for identifying medical instruments according to claim 13 wherein the radio frequency identification tag associated with the instrument is embedded inside the instrument.

19) A method for identifying medical instruments according to claim 13 wherein the radio frequency identification tag associated with the instrument is attached on the outside surface of the medical instrument.

20) A method for identifying medical instruments according to claim 13 wherein each of the radio frequency identification tags is a passive device.

21) A method for identifying medical instruments according to claim 13 wherein each of the radio frequency identification tags is an active device.

22) A method for identifying medical according to claim 13 wherein the reader is electrically connected to a microprocessor.

23) A method for identifying medical instruments in a sealed sterilization case according to claim 13 wherein the reader is in wireless communication with a microprocessor.
